(19) United States
(12) Patent Application Publication
(10) Pub. No.: US 2024/0370690 A1
(43) Pub. Date: Nov. 7, 2024

(54) ENTITY LINKING FOR RESPONSE GENERATION IN CONVERSATIONAL AI SYSTEMS AND APPLICATIONS

(71) Applicant: NVIDIA Corporation, Santa Clara, CA (US)

(72) Inventors: Sagar Bogadi Manjunath, Bengaluru (IN); Shubhadeep Das, West Bengal (IN); Sumit Kumar Bhattacharya, Pune (IN); Oluwatobi Olabiyi, Falls Church, VA (US)

(21) Appl. No.: 18/309,890

(22) Filed: May 1, 2023

(51) Int. Cl. G06N 3/006; G06N 3/045

(52) U.S. Cl. CPC G06N 3/006; G06N 3/045

(57) ABSTRACT

In various examples, query response generation using entity linking for conversational AI systems and applications is described herein. Systems and methods are disclosed that generate embeddings associated with entities that a dialogue system is trained to interpret. The systems and methods may then use the embeddings to interpret requests. For instance, when receiving a request, the systems and methods may generate at least an embedding for an entity included in the request and compare the embedding to the stored embeddings in order to determine that the entity from the request is related to one of the stored entities. The systems and methods may then use this relationship to generate the response to the query. This way, even if the entity is not an exact match to a stored entity, the systems and methods are still able to interpret the query from the user.

### BACKGROUND

Dialogue systems are used in many different applications, such as applications for requesting information (e.g., information about objects, items, features, etc.), scheduling travel plans (e.g., booking arrangements for transportation and accommodations etc.), planning activities (e.g., making reservations, etc.), communicating with others (e.g., making phone calls, starting video conferences, etc.), shopping for items (e.g., purchasing items from online marketplaces, ordering food from a local restaurant, etc.), and/or so forth. Some dialogue systems operate by receiving text—such as text including one or more letters, words, numbers, and/or symbols—that is generated using an input device and/or generated as a transcript of spoken language (e.g., using a speech-to-text algorithm). In some circumstances, the text may represent a request, such as—in a restaurant or food-ordering scenario—a request to inquire about food items provided by a restaurant and/or a request to order one or more of the food items offered by the restaurant. The dialogue systems then process the text using a dialogue manager that is trained to interpret the text. For instance, based on interpreting the text, the dialogue manager may generate a response, such as a response to a query associated with the food items.

In some examples, dialogue systems, such as dialogue systems that use chatbots, use entities in order to interpret queries being asked by users. For example, and for a dialogue system that is associated with ordering food, different food items that are offered may be associated with food name entities, food topping entities, and/or so forth. The food name entities may then be associated with various food items that are provided (e.g., cheeseburgers, pizza, etc.) and the food toppings entities may be associated with various toppings that are provided (e.g., mustard, ketchup, etc.). As such, if a user asks a query, such as “Can I get a cheeseburger with mustard?”, the cheeseburger may be classified as a food name entity and the mustard may be classified as a toppings entity. The dialogue system may then use the entities along with the classifications in order to interpret the query and provide a response back to the user.

However, in some circumstances, a user may ask a query that includes an entity that does not match another entity associated with the dialogue system. For a first example, if food menu items include burgers and drinks, but a user asks about salads, then the dialogue system may provide a response that salads are not offered on the menu. For a second example, and again if food menu items include burgers and drinks, but a user asks about beverages, then the dialogue system may again provide a response that beverages are not offered on the menu. However, in this second example, the dialogue system may make a mistake in responding that beverages are not offered on the menu since the word “beverages” includes a substitute for the word “drinks,” which is what the user is inquiring about.

### SUMMARY

Embodiments of the present disclosure relate to query response generation using entity linking for conversational artificial intelligence (AI) systems and applications. Systems and methods are disclosed that generate embeddings associated with entities that a dialogue system is trained to interpret. The systems and methods may then use the embeddings to interpret requests. For instance, when receiving a request, an embedding for an entity included in the request may be generated and then compared to stored embeddings for stored entities in order to determine that the entity from the request is related to one of the stored entities. The systems and methods may then use this relationship to generate the response to the query. This way, even if the entity is not an exact match to a stored entity (e.g., the entity includes beverages, but the stored entities include drinks), the systems and methods are still able to interpret the query from the user.

In contrast to conventional systems, such as those described above, the current systems are able to interpret requests even when entities associated with the requests do not exactly match stored entities that dialogue systems are able to understand. For example, in a conventional system, if a dialogue system stores data associated with a drinks entity, but a request includes a query associated with a beverages entity, then the dialogue system of the conventional system may be unable to interpret the request since the beverage entity does not match the drinks entity. In contrast, the current systems, in some embodiments, may still be able to interpret the request by determining that the beverages entity is related to the drinks entity using the embeddings for the entities. As such, the current systems may still be able to provide an adequate response to the request.

### BRIEF DESCRIPTION OF THE DRAWINGS

The present systems and methods for query response generation using entity linking for conversational AI systems and applications are described in detail below with reference to the attached drawing figures, wherein:

FIG. 1 is an example data flow diagram for a process of processing requests, using entity linking, to generate responses to the requests, in accordance with some embodiments of the present disclosure;

FIG. 2 illustrates an example of determining information associated with a request, in accordance with some embodiments of the present disclosure;

FIG. 3 illustrates an example of generating embeddings for entities, in accordance with some embodiments of the present disclosure;

FIG. 4 illustrates an example of determining relationships between identified entities and stored entities using embeddings, in accordance with some embodiments of the present disclosure;

FIGS. 5A-5B illustrate an example of determining relationships between identified entities and stored entities using entity categories, in accordance with some embodiments of the present disclosure;

FIG. 6 illustrates an example of determining relationships between identified entities and stored entities that are not provided, in accordance with some embodiments of the present disclosure;

FIGS. 7A-7B illustrate examples of generating responses to requests, in accordance with some embodiments of the present disclosure;

FIG. 8 is a flow diagram showing a method for using entity linking to generate a response to a request, in accordance with some embodiments of the present disclosure;

FIG. 9 is a flow diagram showing a method for determining relationships between identified entities and stored entities using entity categories, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods are disclosed related to query response generation using entity linking for conversational AI systems and applications. For instance, a system(s), such as a dialogue system(s) associated with a chatbot(s), may store data representative of entities. As described herein, an entity may include, but is not limited to, a field, data, text, value, and/or the like that describes an item, place, person, number, and/or so forth. For a first example, and for a food ordering system(s), the system(s) may store data representing food category entities, such as a food names entity, a food sizes entity, and a food toppings entity. In such an example, the food category entities may be associated with specific entities, such as the food names entity being associated with a burger entity, a pizza entity, and a salad entity. For a second example, and for a traveling system(s), the system(s) may store data representing travel category entities, such as a travel type entity, a hotels entity, and a vehicle rentals entity. In such an example, the travel category entities may also be associated with specific entities, such as the travel type entity being associated with a flight entity, a bus entity, a train entity, and a boat entity.

The system(s) may then process the entities using one or more models that are configured to generate embeddings for the entities. As described herein, a model associated with generating embeddings may include, but is not limited to, SimCSE, Word2vec, GloVe, FastText, and/or any other type of model that is able to generate embeddings for entities. The system(s) may then store data associated with the entities. As described herein, the data may represent at least the entity categories, the entities within the entity categories, the embeddings (e.g., vector embeddings corresponding to a semantic or latent space) associated with the entities, and/or relationships associated with the entity categories (which is described in more detail herein). The system(s) may then use the data to interpret and respond to requests.

For example, the system(s) may receive and/or generate input data representing a request, such as input data representing text including one or more letters, words, sub-words, numbers, and/or symbols. For a first example, the system(s) may receive, from a user device, audio data representing user speech and then process the audio data to generate the input data. For a second example, the system(s) may receive, from a user device, the input data representing the request. In any of these examples, the request may include a query for information associated with a topic (e.g., an object, item, feature, attribute, characteristic, etc.), a request to perform an action associated with a topic (e.g., schedule a dinner reservation, book a trip, generate a list, provide content, etc.), and/or any other type of request.

The system(s) may then process, such as by using one or more models associated with speech processing, the input data in order to determine information associated with the request. As described herein, the information may include, but is not limited to, an intent of the request, one or more slots associated with the request, and one or more entities associated with the request. An intent may include a task that a user wants performed such as, but not limited to, requesting information (e.g., information about an object, information about a feature, etc.), scheduling an event (e.g., booking arrangements for transportation and accommodations etc.), planning activities (e.g., making reservations, etc.), communicating with personals or AI agents (e.g., making phone calls, starting video conferences, chatting with a chat bot or a digital avatar, etc.), shopping for items (e.g., purchasing items from online marketplaces, ordering food from a local restaurant, etc.), and/or so forth. Additionally, a slot may provide additional information associated with the intent. Furthermore, an entity may include the value (e.g., text) from a slot.

The system(s) may then process, using one or more models (e.g., the model(s) used to generate the stored embeddings for the stored entities), the one or more entities to generate one or more embeddings associated with the one or more embeddings. Additionally, the system(s) may use the embedding(s) associated with the entity(ies) from the request and the stored embeddings associated with the stored entities to interpret and respond to the request. For example, and for an entity from the request, the system(s) may compare the embedding for the entity to the stored embeddings—e.g., within a latent space—in order to determine similarity values indicating similarities between the embedding and the stored embeddings. The system(s) may then determine that the embedding is related to a stored embedding based on a similarity value satisfying (e.g., being equal to or greater than) a threshold similarity value. Based on that determination, the system(s) may determine that the entity associated with the embedding is related to a stored entity associated with the stored embedding.

For example, such as when the system(s) is associated with ordering food, the system(s) may store a first embedding for a burgers entity, a second embedding for a salads entity, and a third embedding for a drinks entity. The system(s) may then receive a request that represents a query for beverages that are available. As such, the system(s) may determine that the query includes an entity associated with “beverages” and generate a fourth embedding for the beverages entity. The system(s) may then compare the fourth embedding to the stored embeddings in order to determine a first similarity value associated with the fourth embedding and the first embedding, a second similarity value associated with the fourth embedding and the second embedding, and a third similarity value associated with the fourth embedding and the third embedding. Based on the similarity values, the system(s) may determine that the beverages entity is related to the drinks entity. In some examples, the system(s) may make the determination based on the third similarity value satisfying (e.g., being equal to or greater than) a threshold similarity value. As such, even though the query includes an entity (e.g., beverages) that does not match one of the stored entities, the system(s) is still able to relate the entity to the stored entity (e.g., drinks) when generating a response.

In some examples, and as described herein, the entities may be associated with entity categories. In such an example, the system(s) may determine an initial entity category (e.g., a “first entity category”) associated with an entity, such as based on the output from the speech processing model(s). The system(s) may then compare the embedding associated with the entity to stored first embeddings associated with stored first entities within the first entity category. If the system(s) determines, based on the comparing, that the entity is related to a stored first entity within the first entity category, then the system(s) may use that relationship to generate a response. However, if the system(s) determines, based on the comparing, that the entity is not related to any of the stored first entities associated with the first entity category, then the system(s) may perform similar processes to compare the embedding associated with the entity to stored second embeddings associated with second entities within a second entity category to determine whether the entity is related to one of the stored second entities. The system(s) may then continue to perform these processes in order to determine a stored entity that is related to the entity.

In these examples, the system(s) may store data that associates the entity categories with one another and/or indicates a processing order for the entity categories. For a first example, if the system(s) stores data for four entity categories, then the system(s) may further store data that associates the entity categories with one another. For a second example, and again if the system(s) stores data for fourth entity categories, then the system(s) may further store data indicating an order that includes a first entity category, followed by a second entity category, followed by a third entity category, and finally followed by a fourth entity category. This way, even if the speech processing model(s) mistakenly determines a wrong entity category associated with an entity, the system(s) is still able to determine the correct entity category and/or determine the correct stored entity that is related to the entity.

In some examples, the system(s) may further store data associated with entities that are not provided. For example, such as when the system(s) is again associated with ordering food, the system(s) may store first data for food item entities that are provided and second data associated with food item entities that are not provided. The system(s) may then again perform the processes described herein to determine that an entity from a request is related to one of the second item entities. Additionally, the system(s) may use that determination to generate a response to the request, which is described in more detail here.

The system(s) may then use the relationships between the entities to generate responses to requests. In some examples, to generate responses, the system(s) may use templates that represent structures for responses. For instance, a template may include at least one or more words, a first placeholder(s) for an entity(ies) included in a request, and/or a second placeholder(s) for an entity(ies) that is related to the entity(ies) included in the request. For example, and using the example above, even if the request includes the entity “beverages,” the system(s) may use a template to generate a response that includes “Our drinks that we provide include . . . ” based on the relationship between the beverages entity and drinks entity. Additionally, or alternatively, in some examples, to generate responses, the system(s) may use one or more third models, such as a language model(s) that uses the requests and/or the entity relationships to generate the responses.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more language models—such as large language models LLMs, that process text, image, sensor, and/or audio data, systems for performing light transport simulation, systems for performing collaborative content creation for 3D assets, systems implemented at least partially using cloud computing resources, and/or other types of systems.

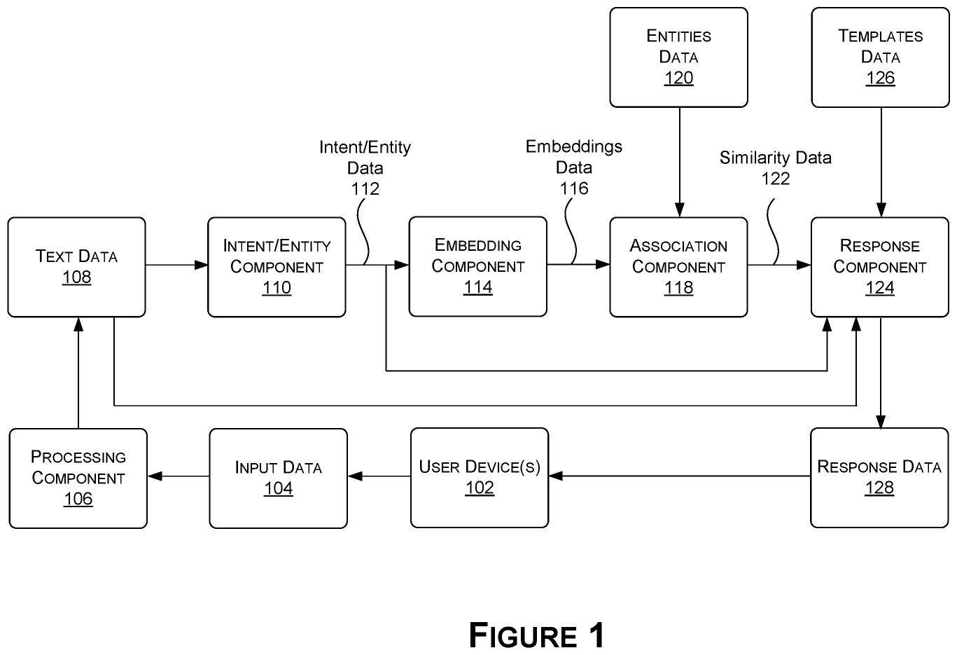

FIG. 1 is an example data flow diagram for a process 100 of processing requests using entity linking, to generate responses to the requests, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include a user device(s) 102 providing input data 104. In some examples, the input data 104 may include audio data generated (e.g., using a microphone(s)) and/or sent by the user device(s) 102, where the audio data represent user speech from one or more users. Additionally, or alternatively, in some examples, the input data 104 may include text data generated (e.g., using a keyboard, touchscreen, and/or other input device) and/or sent by the user device(s) 102, where the text data represents one or more letters, words, numbers, and/or symbols. While these are just a couple example types of data that the input data 104 may include, in other examples, the input data 104 may include any other type of data.

The process 100 may include a processing component 106 that is configured to process the input data 104 in order to generate text data 108. For a first example, such as when the input data 104 includes audio data representing user speech, the processing component 106 may include one or more speech-processing models, such as an automatic speech recognition (ASR) model(s), a speech to text (STT) model(s), a natural language processing (NLP) model(s), a diarization model(s), and/or the like, that is configured to generate the text data 108 associated with the audio data. For instance, the text data 108 may represent a transcript (e.g., one or more letters, words, symbols, numbers, etc.) associated with the user speech. For a second example, such as when the input data 104 already includes text data, the process 100 may not include the processing component 106 such that the text data 108 includes the input data 104.

The process 100 may include an intent/entity component 110 that is configured to process the text data 108 in order to determine information associated with a request represented by the text data 108. For instance, the intent/entity component 110 may include one or more models, such as a speech language understanding (SLU) model, an intent recognition model, an entity recognition model, and/or any other type of model that is configured to determine the information. As described herein, the information may include, but is not limited to, an intent associated with the request, one or more slots associated with the intent, and/or one or more entities associated with the one or more slots. The intent/entity component 110 may then output intent/entity data 112 representing the information.

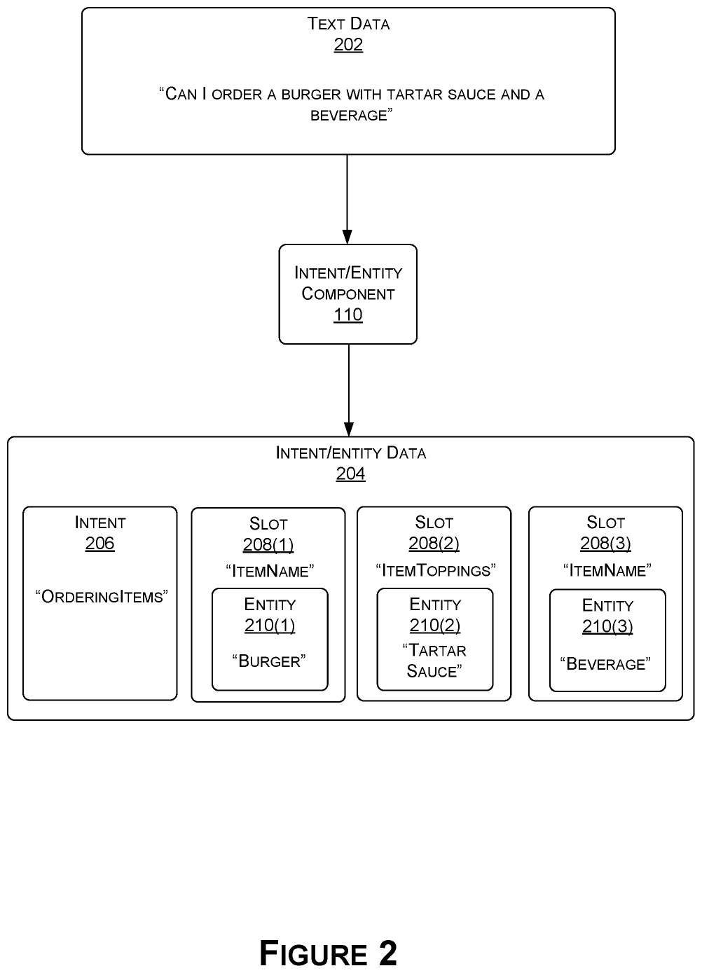

For instance, FIG. 2 illustrates an example of determining information associated with a request, in accordance with some embodiments of the present disclosure. As shown, the intent/entity component 110 may receive text data 202 (which may represent, and/or include, text data 108) representing a request (e.g., a query). For instance, in the example of FIG. 2, the request includes “Can I order a burger with tartar sauce and a beverage.” The intent/entity component 110 may then process the text data 202 and, based on the processing, output intent/entity data 204 (which may represent, and/or include, intent/entity data 112) representing information associated with the request. For instance, and as shown, the intent/entity data 204 represents at least an intent 206 associated with the request, slots 208(1)-(3) associated with the request, and entities 210(1)-(3) (e.g., values) respectively associated with the slots 208(1)-(3).

In the example of FIG. 2, the intent (e.g., “OrderingItems”) is associated with ordering items, the first slot 208(1) (e.g., “ItemName”) is associated names of items, the second slot 208(2) (e.g., “ItemToppings”) is associated with toppings for items, and the third slot 208(3) (e.g., “ItemName”) is also associated with names of items. Additionally, the first entity 210(1) (e.g., a first value) includes “Burger,” the second entity 210(2) (e.g., a second value) includes “Tartar Sauce,” and the third entity 210(3) (e.g., a third value) includes “Beverage.” However, in other examples, the intent 206 may include any other type of intent, the slots 208(1)-(3) may include any other types of slots, and the entities 210(1)-(3) may include any other types of entities.

Referring back to the example of FIG. 1, the process 100 may include an embedding component 114 that is configured to process the intent/entity data 112 and, based on the processing, generate one or more embeddings for one or more of the entities. For instance, as described herein, the embedding component 114 may include one or more models (e.g., machine learning models, neural networks, etc.), such as SimCSE, Word2vec, GloVe, FastText, and/or any other type of model that is able to generate embeddings for entities. Additionally, an embedding for an entity may include a vector that represents the entity, such as by representing the value of the entity. In some examples, the embedding component 114 may generate a respective embedding for each entity. In some examples, the embedding component 114 may generate one or more embeddings for one or more specific entities. In any of the examples, the embedding component 114 may output embedding data 116 representing the embeddings.

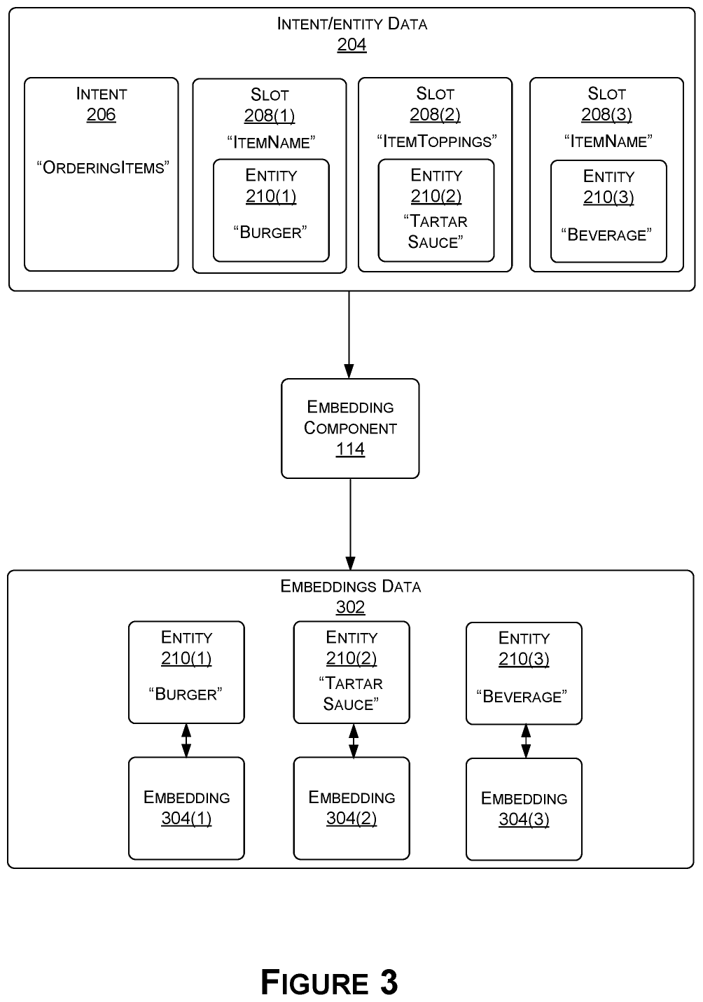

For instance, FIG. 3 illustrates an example of generating embeddings for entities, in accordance with some embodiments of the present disclosure. As shown, the embedding component 114 may process at least a portion of the intent/entity data 204 and, based on the processing, generate embeddings data 302 (which may represent, and/or include, embeddings data 116). In the example of FIG. 3, the embedding component 114 generated a first embedding 304(1) for the first entity 210(1), a second embedding 304(2) for the second entity 210(2), and a third embedding 304(3) for the third entity 210(3). However, in other examples, the embedding component 114 may not generate one or more of the embeddings 304(1)-(3) for one or more of the entities 210(1)-(3).

Referring back to the example of FIG. 1, the process 100 may include an association component 118 that is configured to process the embedding data 116 and entities data 120 and, based on the processing, identify relations between one or more entities from the text data 108 and one or more entities (e.g., stored entities) associated with the entities data 120. For instance, the entities data 120 may represent information associated with stored entities. As described herein, the information for a stored entity may include, but is not limited to, an entity category associated with the stored entity, an embedding associated with the stored entity, and/or any other information. For example, to generate the entities data 120, the stored entities may have been processed by the embedding component 114 (and/or one or more additional and/or alternative models) in order to determine the embeddings for the stored entities. These embeddings may then have been used to generate the entities data 120 associated with the entities.

In some examples, the entities associated with the entities data 120 may include entities for which a dialogue system (e.g., a chatbot) associated with the process 100 is configured to interpret. For a first example, if a dialogue system is associated with ordering food items from a business, then the entities may be associated with items, toppings, sizes, and/or the like that the business provides. For a second example, if a dialogue system is associated with a travel company, then the entities may be associated with travel types, destination locations, hotels, vehicle rental companies, and/or the like that the travel company provides. While these are just a couple example use cases for a dialogue system that is associated with the process 100, in other examples, the dialogue system may be used to perform any other tasks and/or actions.

While these examples describe the entities being associated items and/or services that are provided by a business, company, and/or the like, in other examples, the entities may be associated with items and/or services that are not provided, but which may still help the dialogue system when interpreting requests. For example, if a company associated with a dialogue system provides food items that include pizza and hamburgers, then the entities data 120 may represent a first list that includes a pizza entity and a hamburger entity. However, the entities data 120 may also represent a second list that includes entities for other food items not provided by the company, such as a salad entity and a steak entity. As will be described in more detail below, by including such as a second list, the dialogue system may still be able to determine that entities associated with requests include food items even though such food items are not provided. This may help the dialogue system when generating responses.

In some examples, the entities may be grouped into entity categories. For example, and again using the example where the dialogue manager is associated with ordering food items, the entity categories may include a food names entity, a food sizes entity, a food toppings entity, and/or the like. The food names entity may then include entities that are associated with food items, such as a burger entity, a pizza entity, a sandwich entity, and/or the like. Additionally, the food sizes entity may include entities that are associated with food sizes, such as a small entity, a medium entity, a large entity, and/or the like. Furthermore, the food toppings entity may include entities that are associated with food toppings, such as a ketchup entity, a mustard entity, a lettuce entity, a pickles entity, vegetarian, and/or the like.

In some examples, to determine that an entity associated with the text data 108 is related to a stored entity associated with the entities data 120, the association component 118 may analyze the embedding associated with the entity with respect to the embeddings associated with the stored entities. For example, the association component 118 may compare the embedding associated with the entity to the embeddings associated with the stored entities. Based on the comparison, the association component 118 may determine similarity values between the embedding associated with the entity and the embeddings associated with the stored entities. For instance, in some examples, the association component 118 may perform cosine similarity to determine cosine similarity values between the embedding associated with the entity and the embeddings associated with the stored entities.

In some examples, a similarity value may indicate an amount of similarity between the embedding associated with the entity and an embedding associated with a stored entity (e.g., indicate a similarity between the entity and the stored entity). For example, the higher the similarity value, the more similar the entity is to the stored entity and the lower the similarity value, the less similar the entity is to the stored entity. In some examples, the similarity value may be within a range of values. For example, such as when the association component 118 performs cosine similarity, the range of similarity values may be between −1 and 1. In such an example, a similarity value of 1 may indicate that the entity is very similar (e.g., the same as) the stored entity, a similarity value of −1 may indicate that the entity is very different than the stored entity, and a similarity value between −1 and 1 may indicate an amount of similarity between the entity and the stored entity that is between being very different and very similar. While these examples use a range of values that is between −1 and 1, in other examples, the association component 118 may use any other range of values.

The association component 118 may use one or more techniques to determine that the entity associated with the text data 108 is related to one of the stored entities associated with the entities data 120. In some examples, the association component 118 may determine that the entity is related to a stored entity based on the similarity value satisfying (e.g., being equal to or greater than) a threshold value. For example, if the similarity values are within a range of values (e.g., a range between −1 and 1), then the threshold value may include a value that is within the range (e.g., 0.5, 0.8, 0.9, 0.95, etc.). Additionally, or alternatively, in some examples, the association component 118 may determine that the entity is related to a stored entity based on the similarity value associated with the entity and the stored entity including a highest similarity value. While these are just a couple example techniques of how the association component 118 may use the similarity values to determine that an entity is related to a stored entity, in other examples, the association component 118 may use additional and/or alternative techniques.

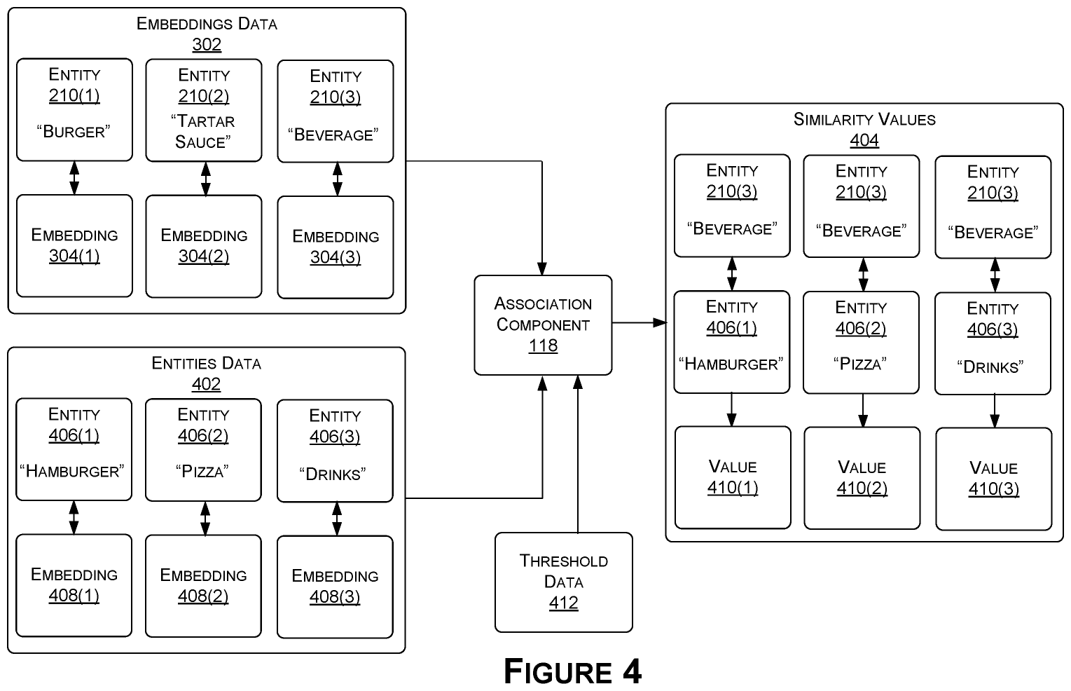

For instance, FIG. 4 illustrates an example of determining relationships between identified entities and stored entities, in accordance with some embodiments of the present disclosure. As shown, the association component 118 may use the embeddings data 302 and entities data 402 (which may represent, and/or include, entities data 120) to determine at least similarity values 404 between the third entity 210(3) and stored entities 406(1)-(3). To determine the similarity values 404, the association component 118 may compare the third embedding 304(3) to a first embedding 408(1) associated with the first stored entity 406(1) (e.g., Hamburger) to determine a first similarity value 410(1), the third embedding 304(3) to a second embedding 408(2) associated with the second stored entity 406(2) (e.g., Pizza) to determine a second similarity value 410(2), and the third embedding 304(3) to a third embedding 408(3) associated with the third stored entity 406(3) (e.g., Drinks) to determine a third similarity value 410(3).

The association component 118 may then use the similarity values 410(1)-(3) to determine that the third entity 210(3) is related to the third stored entity 406(3) (e.g., beverages are related to drinks). In some examples, the association component 118 makes the determination based on the third similarity value 410(3) satisfying (e.g., being equal to or greater than) a threshold value, where the threshold value is represented by threshold data 412. Additionally, or alternatively, in some examples, the association component 118 makes the determination based on the third similarity value 410(3) including the highest value among the similarity values 410(1)-(3). While these are just a couple example techniques of how the association component 118 may use the similarity values 410(1)-(3) to determine that the third entity 210(3) is related to the third stored entity 406(3), in other examples, the association component 118 may use additional and/or alternative techniques.

Referring back to the example of FIG. 1, in some examples, the association component 118 may use “negative” language when identifying relationships between one or more entities from the text data 108 and one or more stored entities associated with the entity data 120. For a first example, an entity from the text data may include “without meat,” where the word “without” is the negative language. In such an example, the association component 118 may perform one or more of the processes described herein to associate the entity “without meat” with a store entity “vegetarian.” For a second example, an entity from the text data may include “plain,” where the word “plain” is the negative language. In such an example, the association component 118 may perform the processes described herein to associate the entity “plain” with a store entity “no toppings.”

In some examples, the association component 118 may use the entity categories when identifying relations between one or more entities from the text data 108 and one or more stored entities associated with the entities data 120. For instance, and as described herein, the intent/entity data 112 may indicate an initial entity category (e.g., a “first entity category”) associated with an entity. As such, the association component 118 may compare the embedding associated with the entity to stored first embeddings associated with stored first entities within the first entity category. If the association component 118 determines, based on the comparing, that the entity is related to a stored first entity within the first entity category (e.g., using the processes described herein), then the association component 118 may use that relationship to generate a response. However, if the association component 118 determines, based on the comparing, that the entity is not related to any of the stored first entities within the first entity category, then the association component 118 may perform similar processes to compare the embedding associated with the entity to stored second embeddings associated with second entities within a second entity category to determine whether the entity is related to one of the stored second entities. The association component 118 may then continue to perform these processes in order to determine a stored entity that is related to the entity.

When performing such processes, the association component 118 may use an order for the entity categories. For example, the order may indicate the first entity category, followed by the second entity category, followed by a third entity category, and/or so forth. In such an example, the entities data 120 may indicate the order and/or the association component 118 may determine the order when performing one or more of the processes described herein.

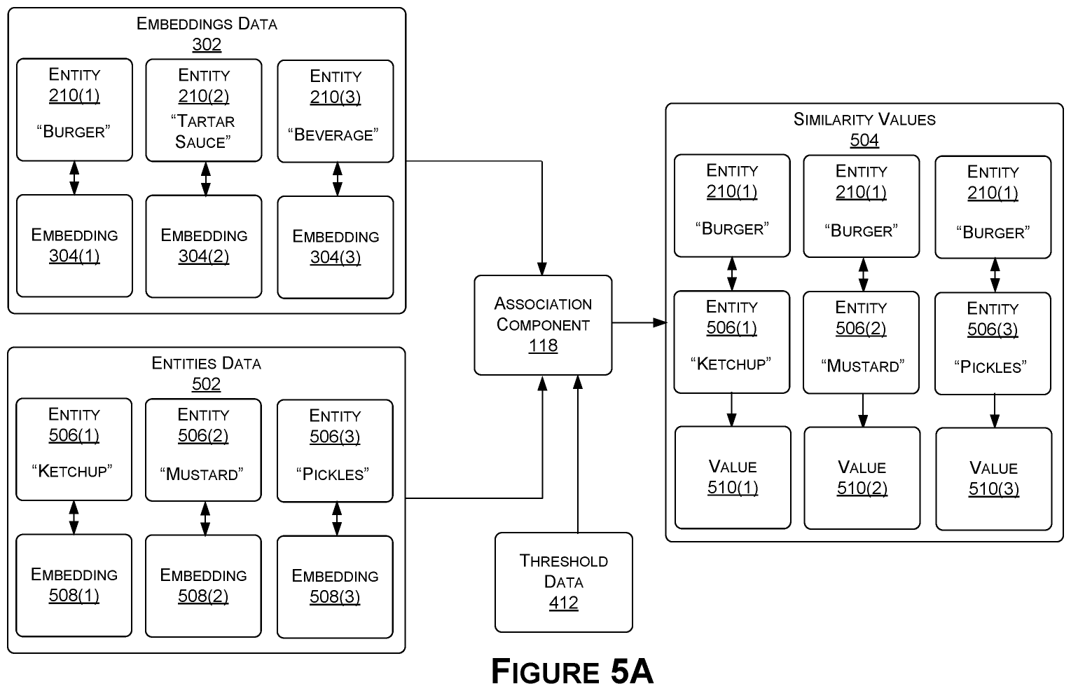

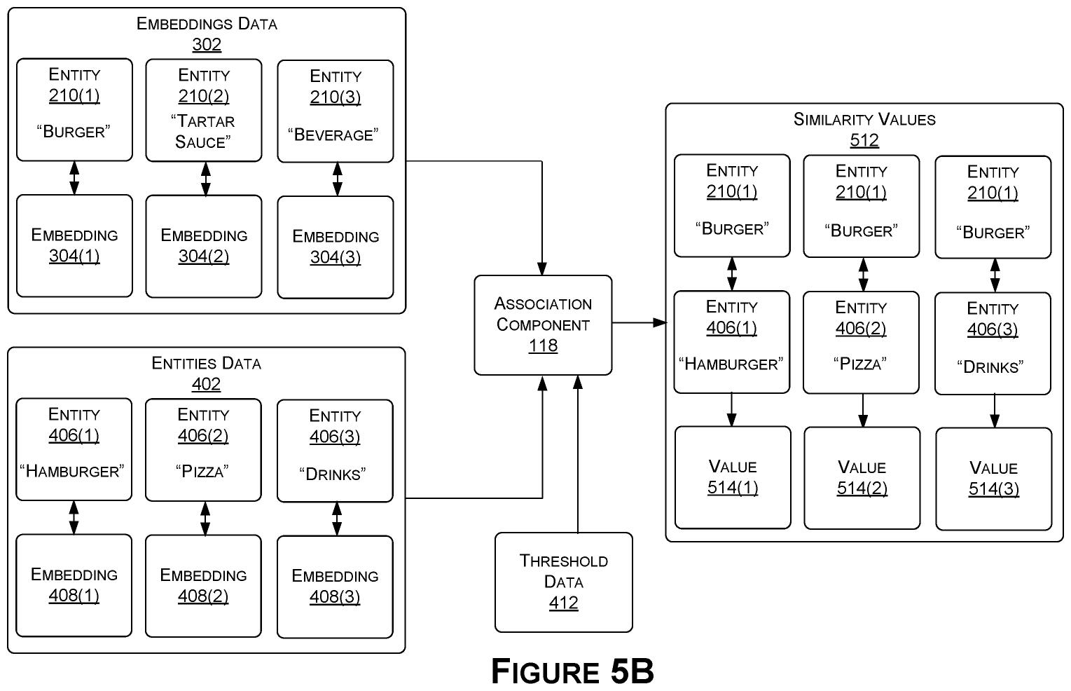

For instance, FIGS. 5A-5B illustrate an example of determining relationships between identified entities and stored entities using entity categories, in accordance with some embodiments of the present disclosure. As shown by the example of FIG. 5A, the association component 118 may use the embeddings data 302 and entities data 502 (which may represent, and/or include, entities data 120) to determine at least similarity values 504 between the first entity 210(1) and stored entities 506(1)-(3). In the example of FIG. 5A, the stored entities 506(1)-(3) may be associated with a first entity category, such as a toppings entity category. To determine the similarity values 504, the association component 118 may compare the first embedding 304(1) to a first embedding 508(1) associated with the first stored entity 506(1) (e.g., Ketchup) to determine a first similarity value 510(1), the first embedding 304(1) to a second embedding 508(2) associated with the second stored entity 506(2) (e.g., Mustard) to determine a second similarity value 510(2), and the first embedding 304(1) to a third embedding 508(3) associated with the third stored entity 506(3) (e.g., Pickles) to determine a third similarity value 510(3).

The association component 118 may then use the similarity values 510(1)-(3) to determine that the first entity 210(1) is not related to any of the entities 506(1)-(3). In some examples, the association component 118 makes the determination based on all of the similarity values 510(1)-(3) not satisfying (e.g., being less than) the threshold value, where the threshold value is again represented by the threshold data 412. As such, the association component 118 may determine to perform similar processes with a second entities category, such as a food names entity category.

For instance, and shown by the example of FIG. 5B, the association component 118 may use the embeddings data 302 and the entities data 402 to determine at least similarity values 512 between the first entity 210(1) and the stored entities 406(1)-(3). In the example of FIG. 5B, the stored entities 406(1)-(3) may be associated with the second entity category, such as the food name entity category. To determine the similarity values 512, the association component 118 may compare the first embedding 304(1) to the first embedding 408(1) associated with the first stored entity 406(1) (e.g., Hamburger) to determine a first similarity value 514(1), the first embedding 304(1) to the second embedding 408(2) associated with the second stored entity 406(2) (e.g., Pizza) to determine the second similarity value 514(2), and the first embedding 304(1) to the third embedding 408(3) associated with the third stored entity 406(3) (e.g., Drinks) to determine a third similarity value 514(3).

The association component 118 may then use the similarity values 514(1)-(3) to determine that the first entity 210(1) is related to the first stored entity 406(1) (e.g., burger is related to hamburger). In some examples, the association component 118 makes the determination based on the first similarity value 514(1) satisfying (e.g., being equal to or greater than) the threshold value, where the threshold value is again represented by the threshold data 412. Additionally, or alternatively, in some examples, the association component 118 makes the determination based on the first similarity value 514(1) including the highest value among the similarity values 514(1)-(3). While these are just a couple example techniques of how the association component 118 may use the similarity values 514(1)-(3) to determine that the first entity 210(1) is related to the first stored entity 406(1), in other examples, the association component 118 may use additional and/or alternative techniques.

Referring back to the example of FIG. 1, in some examples, and as described herein, the entities data 120 may represent entities (e.g., a list of entities), such as items, that are not provided. For example, if a company associated with a dialogue system provides food items that include pizza and hamburgers, then the entities data 120 may represent a first list that includes a pizza entity and a hamburger entity. However, the entities data 120 may also represent a second list that includes entities for other food items not provided by the company, such as a salad entity and a steak entity. By including such as second list, a dialogue system may still be able to determine that entities associated with requests include food items even though such food items are not provided. This may help the dialogue system when generating responses.

In some embodiments, where a direct match is not found in the list of entities based on a search of the latent or semantic space for a similar embedding, a large language model (LLM) may be queried with the text from the query, the closest entities found, and/or additional information, and the LLM may be used to help determine a closest entity. For example, the LLM may be queried for synonyms or slang terms of an item, topping, size, etc. in the query, and the synonyms or slang terms may be converted to an embedding, and a search may be performed in the embedding space to determine if any entities match any of the synonyms or slang terms. In this way, an embedding may be found for one of the alternative synonyms or slang words, and the corresponding entity may be associated with the query. As an example, where a user request “pop,” synonyms for pop may be returned by the LLM, such as “soda” or “beverage.” Once soda or beverage are returned, embeddings may be generated for these terms, and the embedding space may be searched to find that the entity is “beverages.” As such, the proper entity may be determined even where an initial similarity for “pop” was not identified in the embedding space. In such examples, the LLM may be queried each time there is not a direct match, or the LLM may be queried each time the dissimilarity is greater than some threshold in the embedding space.

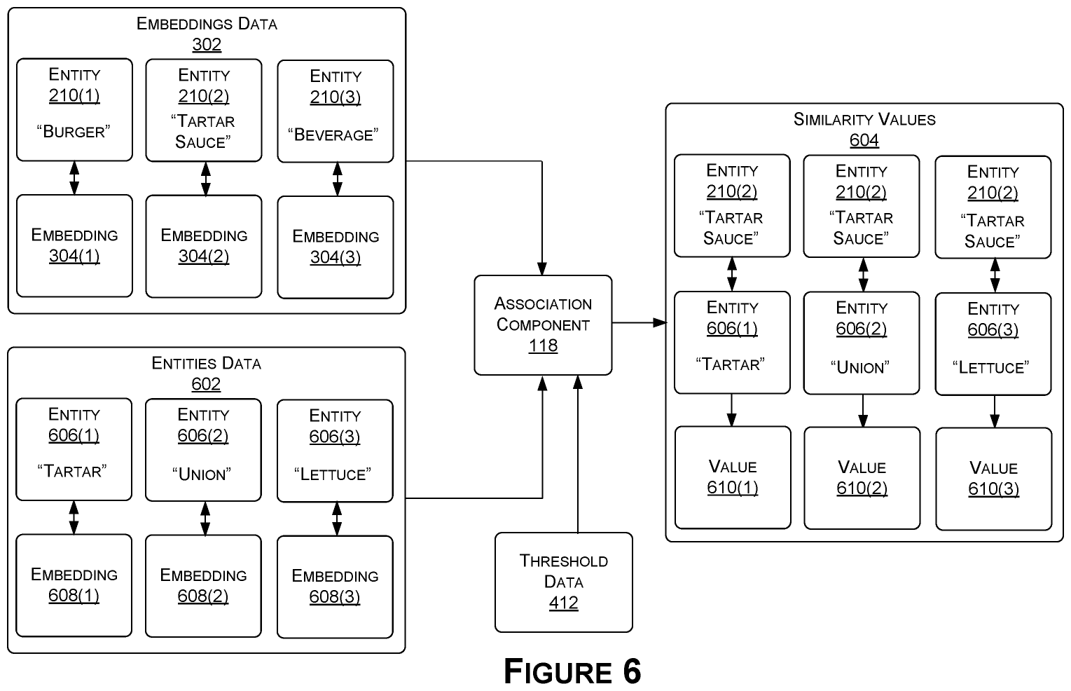

FIG. 6 illustrates an example of determining relationships between identified entities and stored entities that are not provided, in accordance with some embodiments of the present disclosure. As shown, the association component 118 may use the embeddings data 302 and entities data 602 (which may represent, and/or include, entities data 120) to determine at least similarity values 604 between the second entity 210(2) and stored entities 606(1)-(3). In the example of FIG. 6, the stored entities 606(1)-(3) may be associated with toppings not provided, but which may still be asked for by users To determine the similarity values 604, the association component 118 may compare the second embedding 304(2) to a first embedding 608(1) associated with the first stored entity 606(1) (e.g., Tartar) to determine a first similarity value 610(1), the second embedding 304(2) to a second embedding 608(2) associated with the second stored entity 606(2) (e.g., Onion) to determine a second similarity value 610(2), and the second embedding 304(2) to a third embedding 608(3) associated with the third stored entity 606(3) (e.g., Lettuce) to determine a third similarity value 610(3).

The association component 118 may then use the similarity values 610(1)-(3) to determine that the second entity 210(2) is related to the first stored entity 606(1) (e.g., tartar sauce is related to tartar). In some examples, the association component 118 makes the determination based on the first similarity value 610(1) satisfying (e.g., being equal to or greater than) the threshold value, where the threshold value is again represented by the threshold data 412. Additionally, or alternatively, in some examples, the association component 118 makes the determination based on the first similarity value 610(1) including the highest value among the similarity values 610(1)-(3). While these are just a couple example techniques of how the association component 118 may use the similarity values 610(1)-(3) to determine that the second entity 210(2) is related to the first stored entity 606(1), in other examples, the association component 118 may use additional and/or alternative techniques.

Referring back to the example of FIG. 1, the association component 118 may output similarity data 122 representing the relationships between the entities associated with the text data 108 and the stored entities associated with the entities data 120. The process 100 may then include a response component 124 that is configured to process the similarity data 122, the intent/entity data 112, the text data 108, and/or templates data 126 in order to generate a response to the request, where the response is represented by response data 128. For instance, in some examples, the response component 124 may use the templates data 126 to generate the response, where the templates data 126 represents templates for possible responses. For example, a template may include one or more words, a first placeholder(s) associated with an entity(ies) associated with the text data 108, and/or a placeholder(s) associated with the stored entity(ies) that is related to the entity(ies).

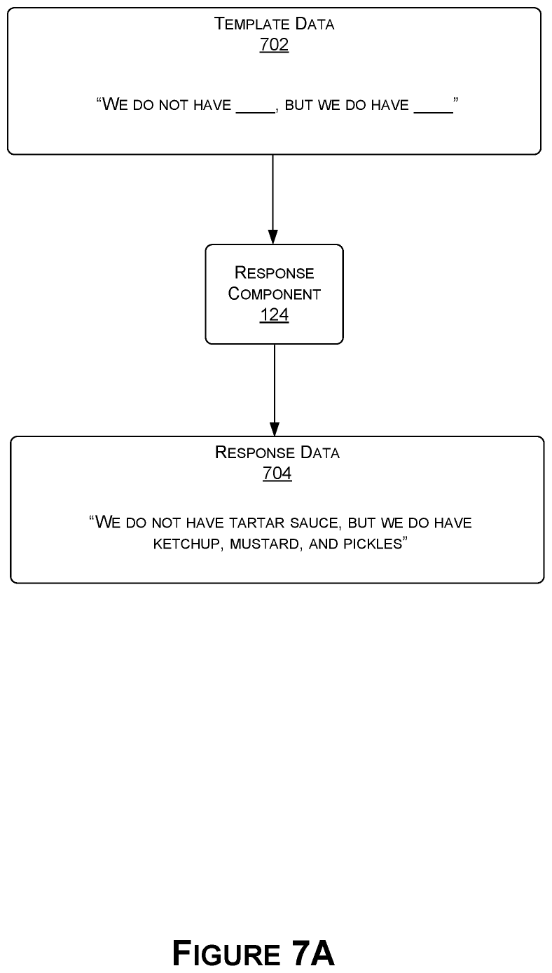

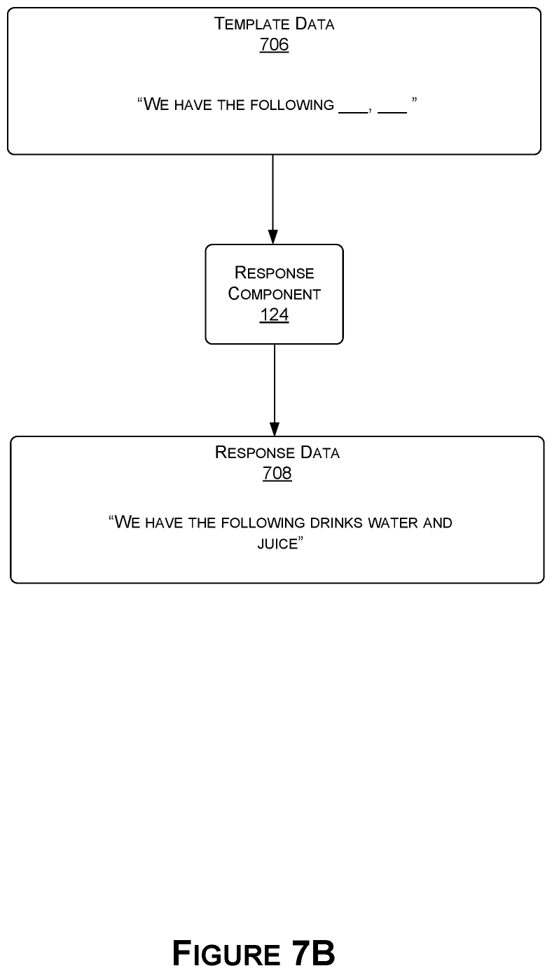

For instance, FIG. 7A illustrates a first example of generating a response to a request, in accordance with some embodiments of the present disclosure. As shown, the response component 124 may use template data 702 (which may represent, and/or include, templates data 126) representing a template to generate a response represented by response data 704 (which may represent, and/or include, response data 128). For instance, the template may be used when a user requests for an item that is not provided, but items that are similar to the requested item are provided. For example, the template may include one or more words, a first placeholder(s) (indicated by the first dashed line) for an entity(ies) associated with the text data 202, and a second placeholder(s) (indicated by the second dashed line) for an entity(ies) associated with entity data. As such, to generate the response, the response component 124 may input the entities into the correct placeholders. For instance, and in the example of FIG. 7A, the response indicates that the tartar sauce, which was the second entity 206(2), is not provided, but that ketchup, mustard, and pickles, which are the stored entities 506(1)-(3), are provided. In other words, even though the user asked a request that includes a topping that is not provided, the dialogue system is still able to interpret the request and provide a response.

FIG. 7B illustrates a second example of generating a response to a request, in accordance with some embodiments of the present disclosure. As shown, the response component 124 may use template data 706 (which may represent, and/or include, templates data 126) representing a template to generate a response represented by response data 708 (which may represent, and/or include, response data 128). For instance, the template may be used when a user requests an item that is similar to another item that is provided. For example, the template may include one or more words, a first placeholder(s) (indicated by the first dashed line) for an entity(ies) associated with the entity data, and a second placeholder(s) (indicated by the second dashed line) for a list of items. As such, to generate the response, the response component 124 may input the entities into the correct placeholders. For instance, and in the example of FIG. 7B, the response indicates that drinks, which are the third stored entity 406(3), are provided, and the includes a list of a couple drink types. In other words, even though the user asked a request that includes the entity beverages, the dialogue system is still able to interpret the request and provide a response.

Referring back to the example of FIG. 1, in addition to, or alternatively from, the response component 124 using the templates to generate the responses, in other examples, the response component 124 may use one or more models, such as one or more language models (e.g., LLMs), to generate the responses. For instance, as described herein, the model(s) may include, but is not limited to, a Bidirectional Encoder Representations from Transformers (BERT) model, a Generative Pre-Trained Transformer 2 (GPT-2) model, a XLNet model, and/or any other type of language model. When using such a model(s), the response component 124 may use the similarity data 122, the intent/entity data 112, the text data 108, and/or the templates data 126 to generate the responses. In such examples, the prompt for the model may include the query, the entities that are determined, the similarity information, the template information, the history of the conversation, example bot output styles, information from a knowledge base (e.g., extracted using one or more APIs, such as a menu when used for food ordering, or a specification document when used for instruction requests, etc.), and/or any other information.

The process 100 may include providing the response data 128 back to the user device(s) 102. This way, the user device(s) 102 is able to output content associated with a response. For a first example, if the response data 128 includes audio data representing one or more words associated with the response, then the user device(s) 102 may output sound associated with the one or more words. For a second example, if the response data 128 includes image data (e.g., video data) representing the response, then the user device(s) 102 may display one or more images represented by the image data. While these are just a couple examples of content that may be provided by the user device(s) 102, in other examples, the user device(s) 102 may output any other type of content.

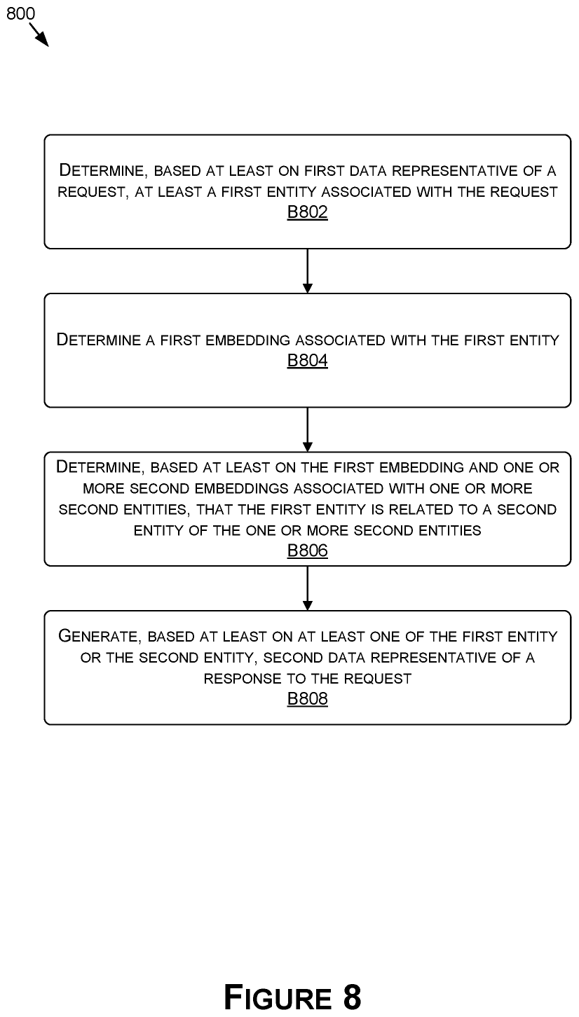

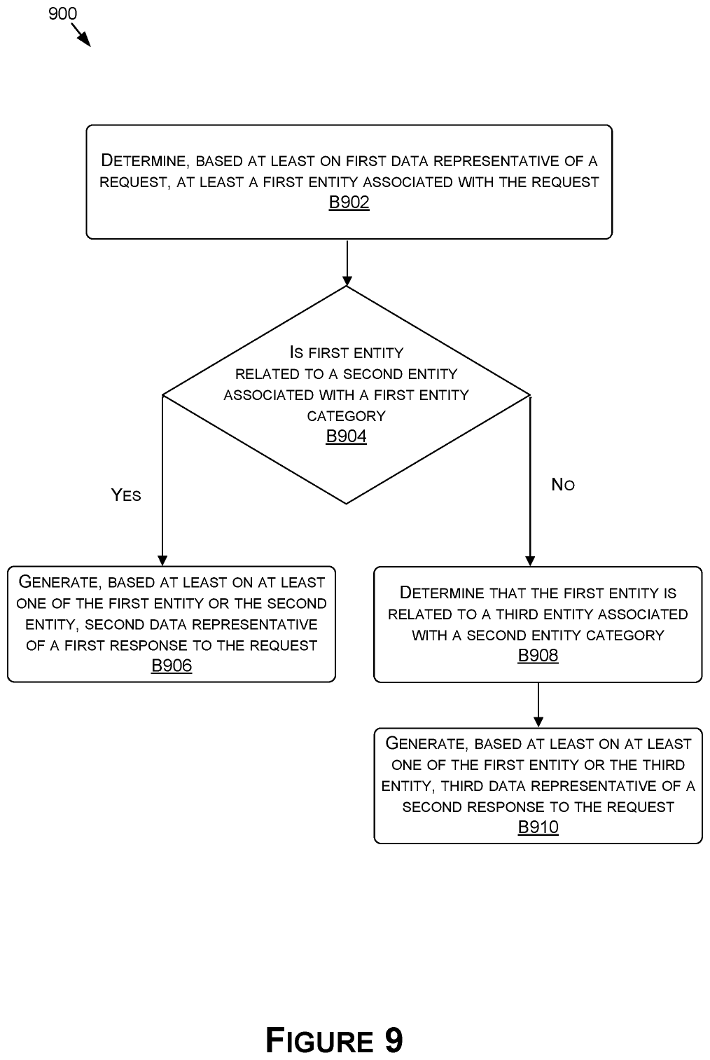

Now referring to FIGS. 8 and 9, each block of the methods 800 and 900, described herein, comprises a computing process that may be performed using any combination of hardware, firmware, and/or software. For instance, various functions may be carried out by a processor executing instructions stored in memory. The methods 800 and 900 may also be embodied as computer-usable instructions stored on computer storage media. The methods 800 and 900 may be provided by a standalone application, a service or hosted service (standalone or in combination with another hosted service), or a plug-in to another product, to name a few. In addition, methods 800 and 900 are described, by way of example, with respect to FIG. 1. However, the methods 800 and 900 may additionally or alternatively be executed by any one system, or any combination of systems, including, but not limited to, those described herein.

FIG. 8 is a flow diagram showing a method 800 for using entity linking to generate a response to a request, in accordance with some embodiments of the present disclosure. The method 800, at block B802, may include determining, based at least on first data representative of a request, at least a first entity associated with the request. For instance, the intent/entity component 110 may process the text data 108 representing the request. Based on the processing, the intent/entity component 110 may determine at least the first entity associated with the request. In some examples, the intent/entity component 110 may further determine, based on the processing, an intent associated with the request, an entity category associated with the first entity, and/or other information associated with the request. The intent/entity component 110 may then output intent/entity data 112 representing at least the first entity.

The method 800, at block B804, may include determining a first embedding associated with the first entity. For instance, the embedding component 114 may process intent/entity data 112 and, based on the processing, generate the first embedding associated with the first entity.

The method 800, at block B806, may include determining, based at least on the first embedding and one or more second embeddings associated with one or more second entities, that the first entity is related to a second entity of the one or more second entities. For instance, the association component 118 may compare the first embedding to the one or more second embeddings in order to determine one or more similarity values between the first embedding and the one or more second embeddings. The association component 118 may then use the similarity value(s) to determine that the first entity is related to the second entity. In some examples, the association component 118 may make the determination based on a similarity value associated with the first entity and the second entity satisfying (e.g., being equal to or greater than) a threshold value.

The method 800, at block B808, may include generating, based at least on at least one of the first entity or the second entity, second data representative of a response to the request. For instance, the response component 124 may generate the response using at least one of the first entity or the second entity. In some examples, the response component 124 generates the response using a template represented by the templates data 126. In some examples, the response component 124 generates the response using one or more models. In either of the examples, the response component 124 may output the response data 128 representing the response.

FIG. 9 is a flow diagram showing a method 900 for determining relationships between identified entities and stored entities using entity categories, in accordance with some embodiments of the present disclosure. The method 900, at block B902, may include determining, based at least on first data representative of a request, at least a first entity associated with the request. For instance, the intent/entity component 110 may process the text data 108 representing the request. Based on the processing, the intent/entity component 110 may determine at least the first entity associated with the request. In some examples, the intent/entity component 110 may further determine, based on the processing, an intent associated with the request, a first entity category associated with the first entity, and/or other information associated with the request. The intent/entity component 110 may then output intent/entity data 112 representing at least the first entity, the intent, and the first entity category.

The method 900, at block B904, may include determining whether the first entity is related to a second entity associated with a first entity category. For instance, the association component 118 may compare a first embedding associated with the first entity to one or more second embeddings associated with one or more second entities included in the first entity category. In some examples, the association component 118 performs the comparison based on the intent/entity component 110 indicating that the first entity is associated with the first entity category. Based on the comparing, the association component 118 may determine whether the first entity is related to one of the second entities.

If, at block B904, it is determined that the first entity is related to the second entity, then the method 900, at block B906, may include generating, based at least on at least one of the first entity or the second entity, second data representative of a first response to the request. For instance, if the association component 118 determines that the first entity is related to the second entity, then the response component 124 may generate the first response using at least one of the first entity or the second entity. In some examples, the response component 124 generates the first response using a template represented by the templates data 126. In some examples, the response component 124 generates the first response using one or more models. In either of the examples, the response component 124 may output the response data 128 representing the first response.

However, if, at block B904, it is determined that the first entity is not related to the second entity, then the method 900, at block B908, may include determining that the first entity is related to a third entity associated with a second entity category. For instance, if the association component 118 determines that the first entity is not related to the second entity, then the association component 118 may compare the first embedding associated with the first entity to one or more third embeddings associated with one or more third entities included in the second entity category. In some examples, the association component 118 performs the comparison based on the second entity category being associated with the first entity category. Based on the comparing, the association component 118 may determine that the first entity is related to one of the third entities.

The method 900, at block B910, may include generating, based at least on at least one of the first entity or the third entity, third data representative of a second response to the request. For instance, the response component 124 may generate the second response using at least one of the first entity or the third entity. In some examples, the response component 124 generates the second response using a template represented by the templates data 126. In some examples, the response component 124 generates the second response using one or more models. In either of the examples, the response component 124 may output the response data 128 representing the second response.

### Example Computing Device

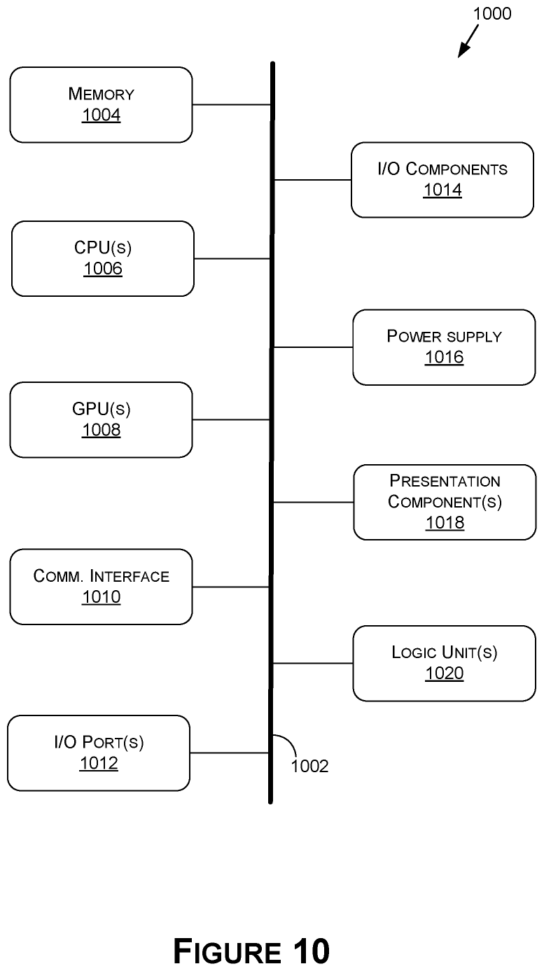

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

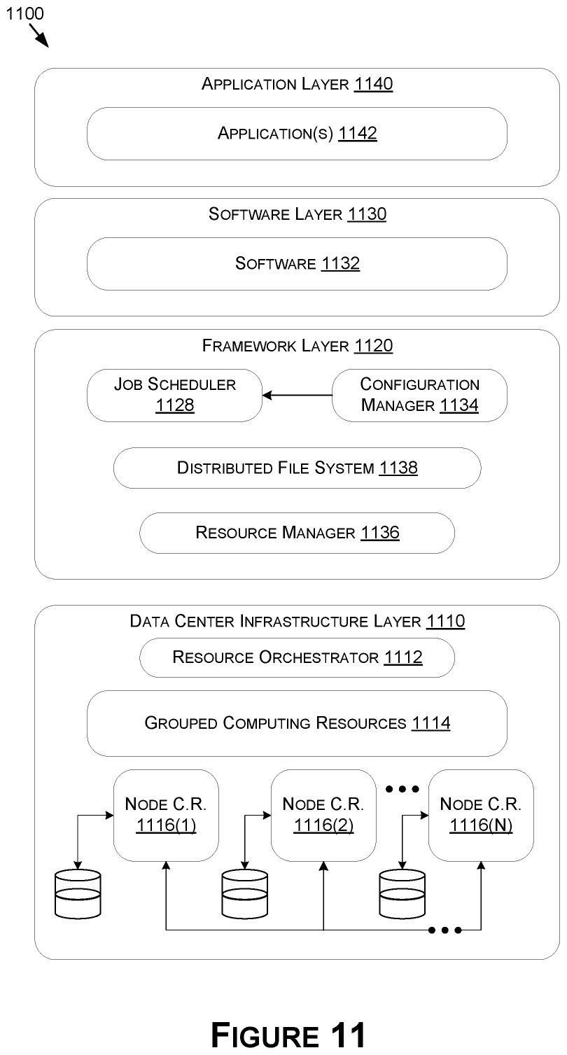

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, using one or more machine learning models and based at least on first data representative of a request, at least a first entity associated with the request;
determining, using the one or more machine learning models, a first embedding associated with the first entity;
determining, based at least on the first embedding and one or more second embeddings associated with one or more of second entities, that the first entity is related to a second entity of the one or more second entities; and
generating, based at least on at least one of the first entity or the second entity, second data representative of a response to the request.

2. The method of claim 1, wherein the determining that the first entity is related to the second entity comprises:
determining, based at least on the first embedding and the one or more second embeddings associated with the one or more of second entities, one or more values indicating one or more similarities between the first entity and the one or more second entities; and
determining, based at least on the one or more values, that the first entity is related to the second entity.

3. The method of claim 1, wherein the determining that the first entity is related to the second entity comprises:
determining, based at least on comparing the first embedding to the one or more second embeddings associated with the one or more of second entities, one or more values indicating one or more similarities between the first entity and the one or more second entities;
determining that the second entity is associated with a value of the one or more values that satisfies a threshold value; and
determining, based at least on the second entity being associated with the value that satisfies the threshold value, that the first entity is related to the second entity.

4. The method of claim 1, further comprising:
determining, using the one or more machine learning models and based at least on the first data representative of the request, that the first entity is associated with an entity category,
wherein the one or more second entities are also associated with the entity category, and wherein the determining that the first entity is related to the second entity is further based at least on the first entity and the one or more second entities being associated with the entity category.

5. The method of claim 1, further comprising:
determining, based at least on the first embedding and one or more third embeddings associated with one or more of third entities, that the first entity is not related to the one or more third entities,
wherein the determining that the first entity is related to the second entity occurs based at least on the first entity not being related to the one or more third entities.

6. The method of claim 5, wherein:
the one or more third entities are associated with a first entity category;
the one or more second entities are associated with a second entity category that is related to the first entity category, and
the determining that the first entity is related to the second entity further occurs based at least on the second entity category being related to the first entity category.

7. The method of claim 1, wherein the generating the second data representative of the response to the request comprises:
receiving a template associated with the response, the template including at least one or more words and one or more slots associated with inputting one or more entities; and
generating the second data representative of the response by inputting the at least one of the first entity or the second entity into the one or more slots.

8. The method of claim 1, wherein the generating the second data representative of the response to the request comprises generating, using one or more large language models (LLMs) and based at least on the first data representative of the request, the first entity, and the second entity, the second data representative of the response to the request.

9. The method of claim 1, wherein:
the determining the at least the first entity associated with the request uses one or more first machine learning models of the one or more machine learning models; and
the determining the first embedding associated with the first entity uses one or more second machine learning models of the one or more machine learning models.

10. The method of claim 1, wherein one of:
the response includes at least a first word associated with the second entity; or
the response includes at least a second word associated with a third entity that is related to the second entity.

11. A system comprising:
one or more processing units to:
determine, using one or more machine learning models and based at least on first data representative of a request, at least a first entity associated with the request;
determine, using the one or more machine learning models, a first embedding associated with the first entity;
determine, based at least on a latent space comparison between the first embedding and one or more second embeddings associated with one or more of second entities, that the first entity is related to a second entity of the one or more second entities; and
output, based at least on at least one of the first entity or the second entity, second data representative of a response to the request.

12. The system of claim 11, wherein the determination that the first entity is related to the second entity comprises:
determining, based at least on the first embedding and the one or more second embeddings associated with the one or more of second entities, one or more distances in the latent space indicating one or more similarities between the first entity and the one or more second entities; and
determining, based at least on the one or more distances, that the first entity is related to the second entity.

13. The system of claim 11, wherein the determination that the first entity is related to the second entity comprises:
determining, based at least on the latent space comparison, one or more similarities between the first entity and the one or more second entities;
determining that the second entity is associated with similarity that satisfies a threshold value; and
determining, based at least on the second entity being associated with the similarity that satisfies the threshold value, that the first entity is related to the second entity.

14. The system of claim 11, wherein the one or more processing units are further to:
determine, using the one or more machine learning models and based at least on the first data representative of the request, that the first entity is associated with an entity category,
wherein the one or more second entities are also associated with the entity category, and wherein the determination that the first entity is related to the second entity is further based at least on the first entity and the one or more second entities being associated with the entity category.

15. The system of claim 11, wherein the one or more processing units are further to:
determine, based at least on the first embedding and one or more third embeddings associated with one or more of third entities, that the first entity is not related to the one or more third entities,
wherein the determination that the first entity is related to the second entity occurs based at least on the first entity not being related to the one or more third entities.

16. The system of claim 11, wherein the one or more processing units are further to one of:
generate the second data representative of the response by at least inputting the at least one of the first entity or the second entity into one or more slots of a template associated with the response; or
generate, using one or more second machine learning models and based at least on the first data representative of the request, the first entity, and the second entity, the second data representative of the response to the request.

17. The system of claim 11, wherein:
the determination of the at least the first entity associated with the request uses one or more first machine learning models of the one or more machine learning models; and
the determination of the first embedding associated with the first entity uses one or more second machine learning models of the one or more machine learning models.

18. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

19. A processor comprising:
one or more processing units to generate first data representative of a response associated with a request, wherein the response is generated based at least on a first entity included in the request and a second entity that is related to the first entity, the first entity being related to the second entity based at least on a first embedding associated with the first entity and a second embedding associated with the second entity.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
